(19) United States
(12) Patent Application Publication
(10) Pub. No.: US 2004/0119580 A1
(43) Pub. Date: Jun. 24, 2004

(54) Remote keyless entry system and method of controlling same using voice commands

(75) Inventors: Christopher Spielman, Redford, MI (US); Christopher Nascimento, Rochester Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI

(21) Appl. No.: 10/327,253

(22) Filed: Dec. 20, 2002

(51) Int. Cl. H04Q 1/00; G05B 19/00

(52) U.S. Cl. 340/5.52; 340/426.36

(57) ABSTRACT

A vehicle remote keyless entry (RKE) system and a method of controlling the operation of at least one vehicle device using voice commands includes a remote control unit transmitting a control signal and a receiver module mounted to the vehicle for receiving the control signal. The remote control unit includes a microphone for receiving a voice command and a processor connected to the microphone for recognizing the voice command and generating a control signal. The receiver module receives the control signal transmitted from the remote control unit and generates a control signal through a data bus connected to the at least one vehicle device to control the operation of the at least one vehicle device.

### BACKGROUND OF THE INVENTION

1. Field of the Invention

The present invention generally relates to a keyless entry system for a vehicle, and more particularly, to a voice controlled vehicle remote keyless entry system and a method for controlling the system using voice commands to control the operation of at least one vehicle device.

2. Background Art

Generally, remote keyless entry (RKE) systems are commonly integrated with vehicle locking systems to allow a user to lock and unlock vehicle doors, trunks, and control alarm systems without the need to use a key. Of particular concern to the present invention are RKE systems that use a portable transmitter unit as a code input device. The transmitter devices in such systems typically include a small, handheld transmitter housing in the form of a key fob that can be easily mounted to a user's key chain. One or more small switch buttons are located on the housing to allow the user to send the desired control signals to a receiver unit mounted on the vehicle.

While such RKE arrangements have significantly increased user convenience, these systems still require a user to physically grab the transmitter housing and actuate a switch button thereon. However, there are times when neither hand is readily free, thereby requiring the user to put down items they may have been carrying so that the transmitter can be grasped. As a consequence, a need exists for a RKE transmitter that can be operated “hands-free.”

Attempts have been made to provide a “hands-free” wireless-type lock control system that involve replacing the transmitter device with a passive transponder unit. One example is disclosed in U.S. Pat. No. 5,929,769 (Garnault). In this system a transmitter unit is located on the vehicle, and is arranged to communicate with a transponder carried by the user when ever the transponder is within a predetermined vicinity of the transmitter. If the transponder is authorized, the transmitter will control opening or unlocking of the vehicle member. The problem with such “passive” systems is that they are generally limited only to opening or unlocking functions, and require the user to be in very close proximity to the receiver.

Further, vehicle RKE systems are being expanded to provide control of other externally located devices, such as a home security or lighting system, and a garage door opener. Hand-held transmitter housings have limited real estate for additional switch buttons without undesirably making the housing larger. Hand-held “passive” systems would not have the capability of allowing control of these external devices from a remote location, such as while seated in the vehicle. As a consequence, a need exists for a RKE transmitter device capable of both “hands-free” operation, and for allowing control of multiple devices without a corresponding enlargement of the transmitter housing.

### SUMMARY OF THE INVENTION

Accordingly, in one example the present invention provides a remote keyless entry system for selectively controlling operation of at least one vehicle device and a method for controlling the system using voice commands to operate at least one device of the vehicle is disclosed. The vehicle remote keyless entry system includes a remote control unit including a microphone for receiving a voice command and a processor for generating a control signal. The remote control unit includes a housing having a microphone disposed within arranged for receiving a voice command.

A processor is disposed within the housing and is connected to the microphone. The processor includes a voice recognition circuit for detecting and recognizing the voice command received from the microphone. The voice recognition circuit compares the voice command against a memory arrangement having control signal values corresponding to stored voice commands. A controller in communication with the voice recognition circuit generates a control signal based on output from the voice recognition circuit. A transmitter in communication with the processor transmits the control signal to a receiver module.

The receiver module is mounted on the vehicle for receiving the control signal from the remote control unit. A controller in the receiver module detects the control signal and determines the vehicle device to control and generates a control signal for use in controlling one or more operations of the vehicle device. A vehicle data bus is provided which links the controller to the at least one vehicle device. The controller transmits the control signal along a vehicle data bus to the vehicle device to control the operation of the device.

The above features, and other features and advantages of the present invention are readily apparent from the following detailed descriptions thereof when taken in connection with the accompanying drawings.

### BRIEF DESCRIPTION OF THE DRAWINGS

FIG. 1 is a perspective view of a vehicle remote keyless entry system of the present invention;

FIG. 2 is an elevated and exploded view of another embodiment of a vehicle remote keyless entry control unit having voice recognition capability in accordance with the present invention;

FIG. 3 is a block circuit diagram of the another aspect of the vehicle remote keyless entry remote control unit of the present invention;

FIG. 4 is a block circuit diagram of the vehicle remote keyless entry system in accordance with an exemplary embodiment of the present invention; and

FIG. 5 is a flowchart of an exemplary implementation of the method of controlling a remote keyless entry system of a vehicle using voice commands in accordance with the present invention.

### DETAILED DESCRIPTION OF THE PREFERRED EMBODIMENT(S)

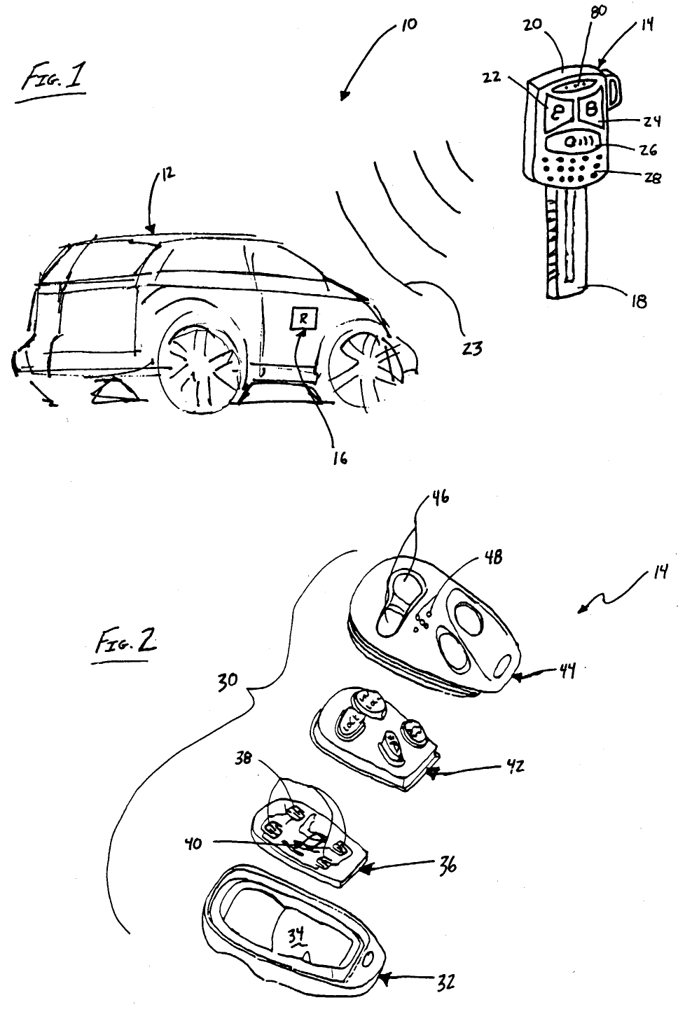

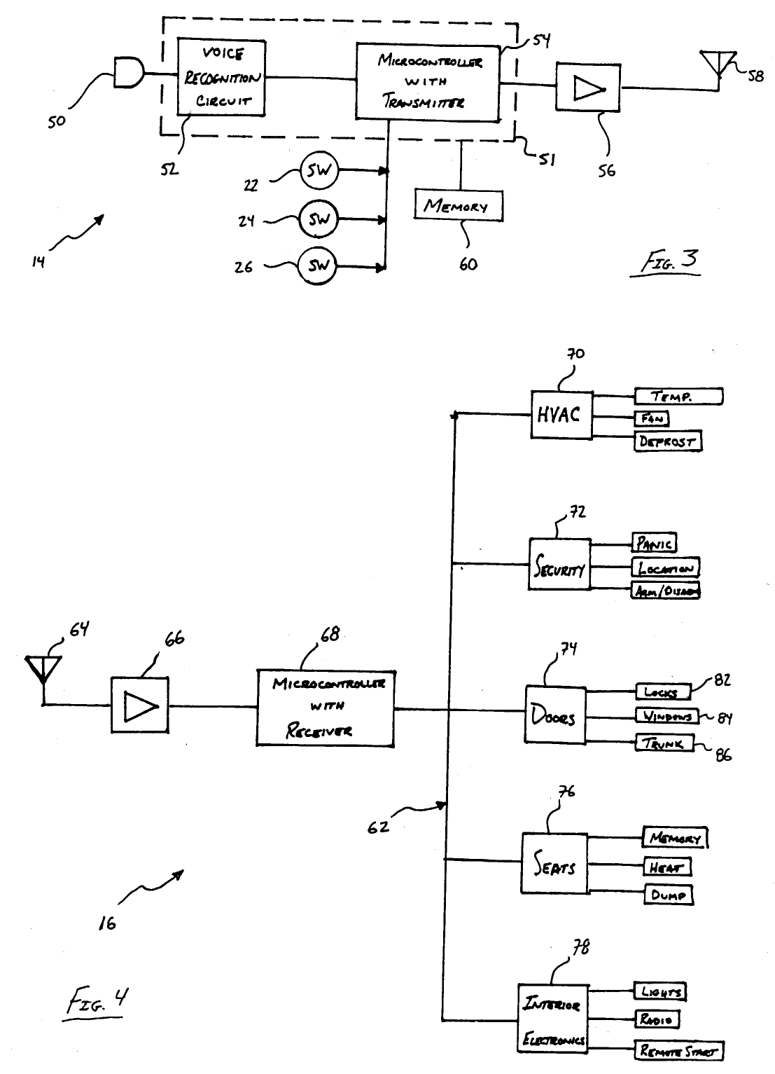

Referring now to the Figures, a vehicle remote keyless entry system for implementation in a vehicle 12 is illustrated in FIG. 1. The remote keyless entry (RKE) system 10 includes a remote control unit 14 carried by a user and a receiver module 16 disposed in the vehicle 12 connected to at least one vehicle device, such as the climate control, audio, security or seat control systems. Remote control unit 14 allows the user to control functions of the vehicle control systems based on switch or voice inputs converted into control signals by the control unit 14. Control unit 14 may be incorporated into the head of a vehicle ignition key 18, as is illustrated in FIG. 1, or alternatively, into a key fob housing as illustrated in FIG. 2.

The remote control unit 14 includes a housing 20 having one or more depressable switches or buttons 22 which allow a user to generate a control signal to control a feature or device of the vehicle 12. For example, as is illustrated in FIG. 1, switch button 22 is programmed to generate a radio frequency (RF) control signal 23 to unlock the vehicle doors while button 24 is programmed to generate a RF control signal to lock the vehicle doors. It should be understood that additional buttons may be incorporated into the transmitter housing 18 to control specific features of the vehicle. Remote control unit 14 a switch button 26 which allows a user to input voice commands through an opening 28 provided in the transmitter housing 20 into a microphone (not shown) provided adjacent the opening 28. A description of the functionality of the voice command control of the remote keyless entry system 10 is discussed in greater detail below.

FIG. 2 illustrates another aspect of the remote keyless entry (RKE) control unit 14 housing of the present invention. RKE control unit housing 30 is formed from an assembly of different components as a key fob securable to a key ring. The components of control unit 14 described in alternative housing 30 are also provided in housing 20. Remote control unit housing 30 includes a handheld base housing portion 32 having an internal space 34 for receiving and holding a printed circuit board 36. The circuit board 36 includes transmitter circuitry as will described below in connection with the block diagram illustrated FIG. 3, as well as at least one switch or button (four are illustrated) 38 and a microphone 40. A switch mat 42 is positioned on top of the circuit board 36 to act as a keypad or button for actuation of each switch 38, and an upper housing portion 44 mates with base portion 32 to complete the assembly. Upper housing portion 44 is formed with openings 46 that align with the respective switch keys of switch mat 42 to allow the switch keys to be accessible to a user, and openings 48 that facilitate the passage of sound to the microphone after the housing is assembled. Except as discussed below, the manner and material used to form each transmitter component is known to those skilled in the art.

Referring now to FIG. 3, a description of an exemplary embodiment of a circuit for the remote control unit 14 of the vehicle remote keyless entry system 10 of the present invention is disclosed. A microphone 50 is connected to a processor 51 arranged to detect and recognize a voice command spoken by the user into the microphone 50. Processor 51 typically includes a voice recognition circuit 52 and a microcontroller 54 which cooperate to recognize the voice command and generate a control signal for transmission to the receiver module 16.

The voice recognition circuit 52 of processor 51 may be incorporated in a variety of fashions. In one aspect of the invention, voice recognition circuit 52 is a separate circuit in communication via parallel or serial communications with the microprocessor based microcontroller 54. In another aspect of the invention, voice recognition circuit 52 is a digital signal processor (DSP) in communication with the controller 54. In yet another aspect of the invention, the voice recognition circuit may be integrated into the controller 54 as a single chip solution, wherein a software algorithm replaces the voice recognition circuit to interpret signals received from the microphone 50.

Controller 54 of processor 51 is connected to a transmitter circuit (not shown), such as a radio frequency (RF) transmission unit arranged to send control signals using any known encryption method. One or more switches 22, 24, 26 are connected to the controller 54 to allow a user to select a vehicle function to control by way of the control unit 14. The transmitter is incorporated into the processor 51 to transmit the control signal 23 to the receiver module 16. A transmitter amplifier 56 receives control signals generated by processor 51 and amplifies the strength of the RF signal transmitted through the antenna 58 for broadcast to the receiver module 16 in the vehicle 12.

Processor 51 includes a memory arrangement denoted as element 60. The memory arrangement 60 may be preprogrammed or programmed by the user to accept and store known speech recognition patterns, such as short code words or phrases, which operate as voice commands to operate one or more features of at least one device of the vehicle 12. For example, processor 51 may include a table of voice commands stored in memory 60, with each voice command being associated with a specific control operation for a device of the vehicle. It is understood that voice recognition circuit 52 or controller 54 may communicate directly with memory arrangement 60 to recognize and compare a voice command received by microphone 50 to a stored command controlling an operation of the at least one device in vehicle 12.

The memory arrangement 60 of processor 51 is preferably programmable so as to learn new voice commands. In one aspect of the present invention, the user may press and hold voice switch button to initiate a programming mode allowing the voice recognition circuit 52 and/or the controller 54 to learn and recognize voices of different users, or specific keywords that can be used in operation of the control unit 14 to be stored in memory 60. The controller 54 of processor 51 generates a control signal associated with the voice command recognized by the voice recognition circuit 52 from the microphone 50 and transmits the control signal to the receiver module 16 in vehicle 12.

In another aspect of the present invention, the voice command is received by microphone 50 and transmitted unprocessed by the processor 51 to the microcontroller 68 in receiver module 16. The memory arrangement 60 is connected to the controller 68, which interprets the voice command and translates the voice command into a control signal to be transmitted across the vehicle data bus 62. The use of voice commands to control vehicle functions allows the present invention to further reduce the size and hardware requirements of a remote keyless entry control unit 14 while increasing the functionality of the system 10. A further description of this functionality will be provided in greater detail below.

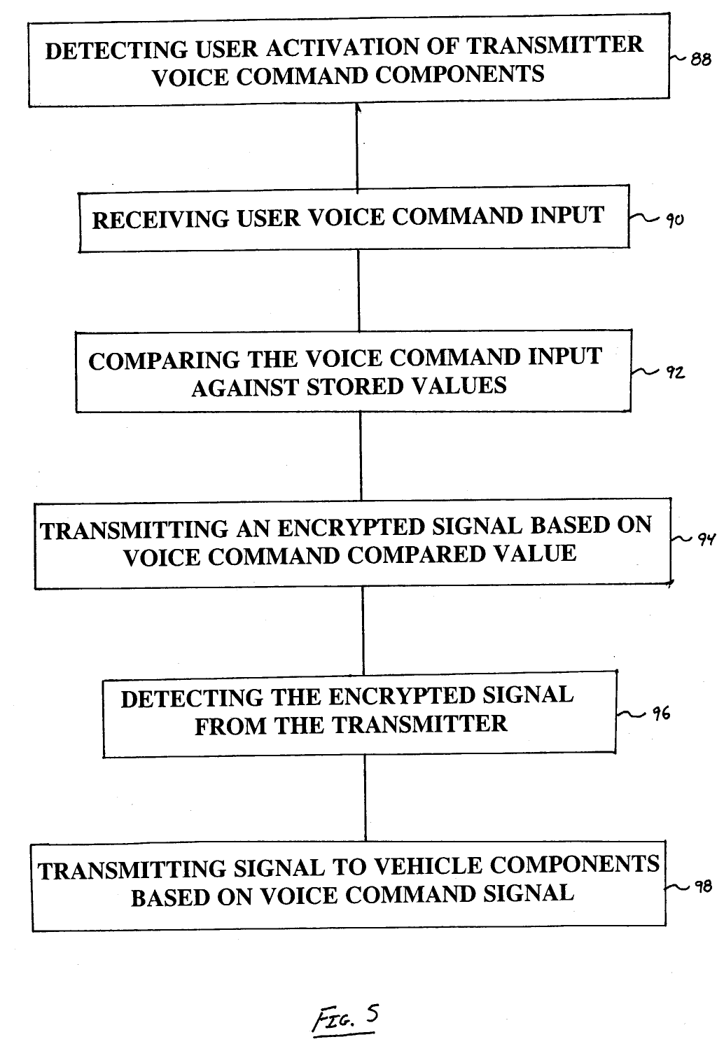

The remote keyless entry control unit 14 includes suitable coding and programming to allow communication of control signals to the receiver module 16 of the remote keyless entry system 10 of the present invention. As shown in the exemplary embodiment illustrated in FIG. 4, the remote keyless entry system 10 includes a receiver module 16 provided in the vehicle 12 in communication with at least one device of a vehicle communication data bus 62 to allow the user control one or more functions of the at least one device. Receiver module 16 includes an antenna 64 which receives the encrypted or coded RF control signal 23 from the control unit 14. A low noise amplifier (LNA) 66 boosts the strength of the signal 23 from control unit 14 and forwards the control signal to a receiver incorporated in a controller 68.

The receiver of controller 68 receives and decodes the control signal 23 from control unit 14. Controller 68 is in communication with a variety of vehicle systems and devices, including climate control 70, security 72, door 74, seat 76 and interior electronic 78 components by monitoring the vehicle data bus 62. It is understood that the controller 68 will communicate with vehicle components or devices through several types of vehicle data buses 62, including a controller area network (CAN), local interconnect network (LIN), J1850 serial communication network or by point to point wiring.

Based on the voice or switch input command signal 23 received from control unit 14, controller 68 generates a control signal based on the control signal 23 received from remote control unit 14. Alternatively, controller 68 transmits the control signal 23 to a vehicle component instructing the component to perform the instructed function. For example, the controller 68 will receive and transmit user voice commands to instruct the climate control subsystem 70 to adjust the cabin temperature, fan speed or activate the defrost elements. Additionally, the controller 68 may receive control signals generated by switch buttons 22 or 24 of control unit 14 instructing the door lock systems to lock or unlock one or more vehicle doors.

In one aspect of the invention, remote keyless entry system 10 may allow two-way communication between the control unit 14 and the microcontroller 68 of the receiver 16. For example, controller 68 may detect an engine running warning condition generated by the security subsystem 72. The controller 68 would generate and transmit a warning RF signal to the control unit 14 to warn the user of the fault condition. The control unit 14 may include a light emitting diode (LED) display 80 or a speaker which would convert the RF warning signal into a visual or audible warning signal for the user.

As is illustrated in FIG. 4, the controller 68 may monitor a variety of functions of each subsystem of the vehicle 12 that are connected to the vehicle data bus 62. In a preferred embodiment of the present invention, vehicle remote keyless entry system 10 allows the user to control a variety of vehicle functions by either voice or switch actuated commands input into the control unit 14. For example, controller 68 monitors a variety of conditions for the door subsystem 74, such as whether the doors are locked 82, the windows closed 84, or the trunk open 86. The user may unlock the doors by actuating switch 24 on the transmitter. Alternatively, the user may instruct the controller 68 to lower the windows by pressing or holding switch button 26 and speaking a voice command into the microphone 50 of the control unit 14. It is understood that other vehicle functions not illustrated in FIG. 4 may also be controlled by voice command, including, but not limited to, opening the vehicle doors, detecting the occupancy of the vehicle and opening the sunroof.

Referring additionally now to FIG. 5, a method of controlling a vehicle remote keyless entry system using voice commands in accordance with the present invention is discussed in greater detail. At step 88, the processor 51 detects the actuation of the voice switch or button 26 by the user. At step 90, the voice recognition circuit 52 of processor 51 receives voice command input from the microphone 50 when the user depresses or holds the voice button 26 while speaking.

At step 92, the voice recognition circuit 52 compares the voice command spoken into the microphone 50 against commands stored in the memory arrangement 60. The voice recognition circuit 52 analyzes the sound waves received by the microphone 50 and compares the voice command against the stored commands in the memory arrangement 60. The voice recognition circuit 52 selects the corresponding control signal code from memory 60 and sends the control signal to the controller 54 for encryption and transmission.

At step 94, the controller 54 of processor 51 transmits an encrypted radio frequency (RF) controller signal 23 through a transmitter unit to the receiver module 16 of the remote keyless entry system 10. At step 96, the controller 68 of receiver module 16 detects and receives the encrypted control signal 23 received from the remote keyless entry control unit 14. At step 98, the controller 68 transmits the control signal through the vehicle data bus 62 to control the function of at least one vehicle device or component based on the user input received from the control unit 14. In another aspect of the present invention, controller 68 generates a control signal based on the signal 23 received from the control unit 14. The control signal generated by controller 68 is transmitted across data bus 62 to control the operation of one or more vehicle devices.

The control signal 23 received from the control unit 14 may either be a voice command interpreted by the voice recognition circuit 52 and processed by the controller 54 or may be a switch actuated output from the switch buttons 22, 24. The controller 68 of receiver module 16 continues to monitor the vehicle components or devices connected to the vehicle data bus 62 to detect any feedback LEAR 0970 PUS from the components. In one aspect of the invention, the controller 68 may generate and send a feedback parameter RF control signal to the control unit 14 in a two-way communication system to notify the user of a condition based on the previous user command.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle remote keyless entry system for controlling the operation of at least one vehicle device comprising:
a remote control unit comprising a microphone for receiving a voice command, a processor connected to the microphone for recognizing the voice command and generating a control signal based on the recognized voice command and a transmitter for transmitting the control signal; and
a receiver module for mounting on the vehicle for receiving the control signal from the remote control unit, the receiver module comprising a controller for generating a control signal for use in controlling the operation of the at least one vehicle device.

2. The vehicle remote keyless entry system of claim 1 wherein the system further comprises a data bus connected to the at least one vehicle device and the controller of the receiver module, wherein the receiver module controller transmits the control signal received from the remote transmitter through the data bus to control the operation of the at least one vehicle device.

3. The vehicle remote keyless entry system of claim 1 wherein the processor comprises a voice recognition circuit for recognizing the received voice command and a controller in communication with the voice recognition circuit programmed for generating the control signal based on output from the voice recognition circuit.

4. The vehicle remote keyless entry system of claim 1 further comprising a memory arrangement connected to the processor for storing a table of keywords, wherein each keyword is associated with one of a plurality of functions of the at least one vehicle device.

5. The vehicle remote keyless entry system of claim 4 wherein the memory arrangement is configured to learn a new keyword, and store the learned keyword in the table in place of an existing keyword already stored in the table.

6. The vehicle remote keyless entry system of claim 4 wherein the memory arrangement is configured to learn a new keyword, and store the learned keyword in the table in association with one of a plurality of functions of the at least one vehicle device.

7. The vehicle remote keyless entry system of claim 1 wherein the memory arrangement is configured to learn a keyword, and store the learned keyword in a memory in association with one of a plurality of functions of the at least one vehicle device.

8. The vehicle remote keyless entry system of claim 1 wherein the processor is configured to generate a control signal for controlling operation of the at least one vehicle device based on a keyword voice command associated with one of a plurality of functions of the at least one vehicle device stored in the memory arrangement.

9. The vehicle remote keyless entry system of claim 1 wherein the remote control unit comprises a housing arranged to receive the microphone and processor and at least one switch button extending through an opening in the housing in communication with the processor.

10. The vehicle remote keyless entry system of claim 9 wherein the at least one switch button of the remote control unit comprises a voice button switch disposed on the remote control unit in communication with the controller, wherein the voice button switch activates the voice recognition circuit to recognize a voice command and initiates a learning mode for the memory arrangement.

11. The vehicle remote keyless entry system of claim 9 wherein the at least one switch button of the remote control unit comprises a pair of switch buttons in communication with the controller arranged to generate a control signal to control an operation of the at least one device of the vehicle.

12. The vehicle remote keyless entry system of claim 9 wherein the remote control unit housing comprises a key fob.

13. The vehicle remote keyless entry system of claim 9 wherein the remote control unit housing is integrated into the head of a vehicle ignition key.

14. A vehicle remote keyless entry system for selectively controlling operation of at least one vehicle device comprising:
a remote control unit comprising;
a housing,
a microphone mounted within the housing for receiving a voice command,
a voice recognition circuit in communication with the microphone for recognizing the voice command received by the microphone,
a memory arrangement in communication with the voice recognition circuit for storing a table of keywords, wherein each keyword is associated with a selected one of a plurality of functions of the at least one vehicle device,
a controller in communication with the voice recognition circuit for generating a control signal based on output from the voice recognition circuit and memory arrangement,
at least one switch button extending through an opening in the housing in communication with the controller, and
a transmitter for transmitting the control signal;
a receiver module for mounting on the vehicle for receiving the control signal from the remote control unit, the receiver module comprising a controller for generating a control signal for use in controlling the operation of the at least one vehicle device; and
a data bus connected to the at least one vehicle device and the controller of the receiver module, wherein the receiver module controller transmits the control signal received from the remote transmitter through the data bus to control the operation of the at least one vehicle device.

15. The remote keyless entry system of claim 14 wherein the at least one switch button of the remote control unit further comprises a voice button switch disposed on the remote transmitter in communication with the controller, wherein the voice button switch activates the voice recognition circuit to recognize a voice command and initiates a learning mode for the memory arrangement.

16. The remote keyless entry system of claim 14 wherein the at least one switch button of the remote control unit further comprises a pair of switch buttons in communication with the controller arranged to generate a control signal to control an operation of the at least one device of the vehicle.

17. The remote keyless entry system of claim 14 wherein the remote transmitter memory is arranged to learn a new keyword, and store the learned keyword in the table in association with one of a plurality of functions of the at least one vehicle device.

18. A method for selectively controlling operation of at least one vehicle device using a voice controlled remote keyless entry system, the method comprising:
detecting a voice command with a microphone mounted in a remote control unit housing;
comparing the received voice command against values stored in a memory arrangement with a voice recognition circuit;
generating a control signal associated with a recognized voice command with a controller based on the stored value in the memory arrangement;
transmitting the control signal to a receiver module mounted in the vehicle; and
transmitting the control signal across a vehicle data bus to control the operation of the at least one vehicle device.

19. The method of claim 18 further comprising detecting the actuation of a voice switch button on the remote control unit to activate the voice recognition circuit and microphone to receive a voice command.

20. The method of claim 18 further comprising:
detecting the actuation of at least one switch button in communication with the controller of the remote control unit;
generating a control signal based on the actuation of the at least one switch button;
transmitting the control signal to the receiver module in the vehicle;
generating a control signal with a controller in the receiver module; and
transmitting the control signal across a vehicle data bus to control the operation of the at least one device.
